(19) United States
(12) Patent Application Publication
(10) Pub. No.: US 2017/0053615 A1
(43) Pub. Date: Feb. 23, 2017

(54) SERVER APPARATUS, INFORMATION PROCESSING SYSTEM, TERMINAL APPARATUS, AND NON-TRANSITORY COMPUTER READABLE MEDIUM

(71) Applicant: FUJI XEROX CO., LTD., Tokyo (JP)

(72) Inventor: Ken ICHIKAWA, Yokohama-shi (JP)

(73) Assignee: FUJI XEROX CO., LTD., Tokyo (JP)

(21) Appl. No.: 14/996,815

(22) Filed: Jan. 15, 2016

(30) Foreign Application Priority Data
Aug. 18, 2015 (JP) 2015-160896

(51) Int. Cl. G09G 5/00; G06F 9/455

(52) U.S. Cl. CPC G09G 5/003; G06F 9/45558; G06F 3/041

(57) ABSTRACT

A server apparatus includes a location information receiving unit that receives location information representing a location of a user's viewpoint in a display region of a terminal apparatus, a region identifying unit that identifies, on a screen provided to the terminal apparatus, a first region determined by the location information and a second region other than the first region, and an image transmitting unit that transmits to the terminal apparatus an image at a first image quality corresponding to the first region for an area of the first region of the provided screen and transmits, to the terminal apparatus, supplemental information that supplements an image at a second image quality lower than the first image quality up to a level of the first image quality after transmitting the image at the second image quality for an area of the second region of the provided screen.

### CROSS-REFERENCE TO RELATED APPLICATIONS

This application is based on and claims priority under 35 USC 119 from Japanese Patent Application No. 2015-160896 filed Aug. 18, 2015.

### BACKGROUND

### Technical Field

The present invention relates to a server apparatus, an information processing system, a terminal apparatus, and a non-transitory computer readable medium.

### SUMMARY

According to an aspect of the invention, there is provided a server apparatus. The server apparatus includes a location information receiving unit that receives location information representing a location of a user's viewpoint in a display region of a terminal apparatus, a region identifying unit that identifies, on a screen provided to the terminal apparatus, a first region determined by the location information and a second region other than the first region, and an image transmitting unit that transmits to the terminal apparatus an image at a first image quality corresponding to the first region for an area of the first region of the provided screen and transmits, to the terminal apparatus, supplemental information that supplements an image at a second image quality lower than the first image quality up to a level of the first image quality after transmitting the image at the second image quality for an area of the second region of the provided screen.

### BRIEF DESCRIPTION OF THE DRAWINGS

Exemplary embodiments of the present invention will be described in detail based on the following figures, wherein:

FIG. 1 illustrates a configuration of an information processing system of an exemplary embodiment the present invention;

FIG. 2 illustrates a hardware configuration of a terminal apparatus;

FIG. 3 is a functional block diagram of the terminal apparatus;

FIG. 4 illustrates a hardware configuration of a server apparatus;

FIG. 5 is a functional block diagram of a virtual machine;

FIG. 6 is a flowchart illustrating an operation sequence of the exemplary embodiment;

FIG. 7 illustrates a partition example of a display region;

FIG. 8 illustrates a first region and a second region;

FIG. 9 is a flowchart illustrating an operational sequence of the exemplary embodiment;

FIG. 10 is a flowchart illustrating an operational sequence of the exemplary embodiment; and

FIG. 11 is a flowchart illustrating an operational sequence of the exemplary embodiment.

### DETAILED DESCRIPTION

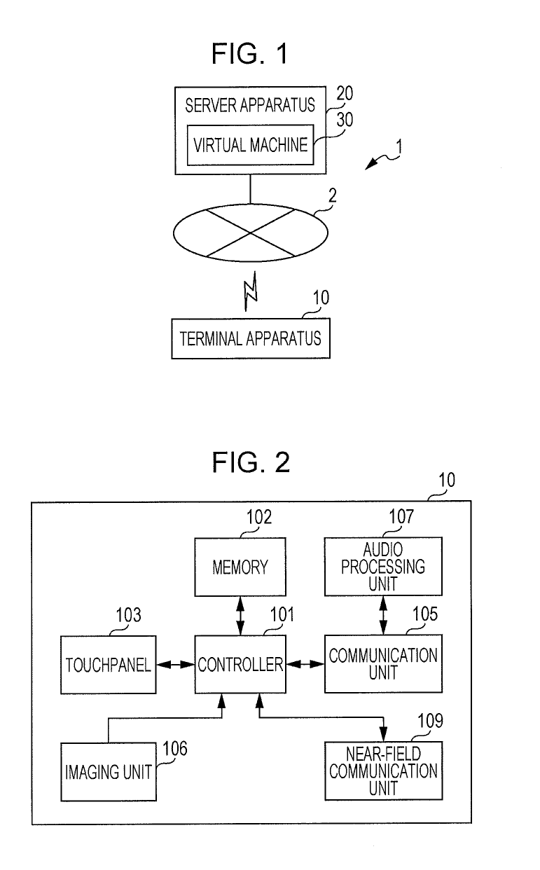

FIG. 1 illustrates a configuration of an information processing system 1 of an exemplary embodiment the present invention. A communication network 2 performs data communication. Plural computers are connected to the communication network 2. The communication network 2 includes wired and wireless communication networks.

A terminal apparatus 10 is an example of a terminal apparatus that works as a client terminal of a thin client. In the exemplary embodiment, the terminal apparatus 10 may be a smart phone or a tablet terminal. The terminal apparatus 10 is connected to the communication network 2 via an access point of a wireless local area network (LAN) included in the communication network 2 or via a wireless base station of a mobile communication system, and then performs data communication via the communication network 2.

The terminal apparatus 10 is a mobile terminal apparatus in the exemplary embodiment, but may be a desk-top type terminal apparatus. For convenience of explanation, FIG. 1 illustrates a single terminal apparatus 10, but the information processing system 1 may include plural terminal apparatuses 10.

A server apparatus 20 has a server function for a thin client. The server apparatus 20 starts up a virtual machine 30 on each user who has been authenticated. The virtual machine 30 is connected to the terminal apparatus 10. The virtual machine 30 transmits to the terminal apparatus 10 information of graphic user interface (GUI) screen used to operate the virtual machine 30. When information is entered or an operation is performed on the GUI screen displayed by the terminal apparatus 10 in response to the GUI information, the virtual machine 30 performs an information processing operation responsive to the input information or the performed operation.

The server apparatus 20 may be an information processing apparatus that is configured to perform cloud computing.

FIG. 2 illustrates an example of a hardware configuration of the terminal apparatus 10. A touchpanel 103 is a combination of a display device, such as a liquid-crystal display, and a sensor that is overlaid on the display screen of the display device to detect the touching of a finger of a user. The touchpanel 103 is an example of an operation unit that is operated by the user. The touchpanel 103 displays characters and the GUI. The sensor of the touchpanel 103 detects a location where the user touches with his or her finger. A controller 101 identifies the operation of the user in accordance with the location detected by the touchpanel 103, and the screen displayed on the touchpanel 103, and controls elements of the terminal apparatus 10 and performs the information processing operation in response to the identified operation.

A communication unit 105 works as a communication interface that performs wireless communication with a wireless base station in a mobile communication network (not illustrated). An audio processing unit 107 includes a microphone and a loudspeaker. In order to perform audio communication, the audio processing unit 107 converts a digital signal into an analog signal when the digital signal of a voice of a communication partner is supplied from the communication unit 105. The analog signal is transferred to the loudspeaker, and the loudspeaker emits the voice of the communication partner in sound. When the microphone picks up a sound, the audio processing unit 107 converts the sound picked up into a digital signal. When the audio communication is performed using the terminal apparatus, the audio processing unit 107 transfers to the communication unit 105 the digital signal into which the voice of the user is converted. The digital signal is transmitted from the communication unit 105 to the mobile communication network, and then transmitted to the terminal apparatus of the communication partner.

A near-field communication unit 109 works as a communication interface that performs wireless communication complying with Bluetooth (registered trademark), or wireless communication complying with communication standards of wireless LAN. The near-field communication unit 109 is connected to an access point of the wireless LAN of the communication network 2 in accordance with the communication that complies with the communication standards of the wireless LAN, and then performs data communication via the communication network 2. An imaging unit 106 includes a lens and a solid-state image sensor, and generates an image focused on the solid-state image sensor through the lens. The image generated by the imaging unit 106 is transferred to the controller 101.

A memory 102 includes a non-volatile memory that continuously stores data. The memory 102 stores an operating system and application programs. In the exemplary embodiment, the memory 102 stores an application program configured to start up and operate the virtual machine 30 (hereinafter referred to as a client application) in addition to related-art application programs to be installed on a tablet terminal or a smart phone. The controller 101 includes a central processing unit (CPU) and a random-access memory (RAM), and executes the operating system and the application programs.

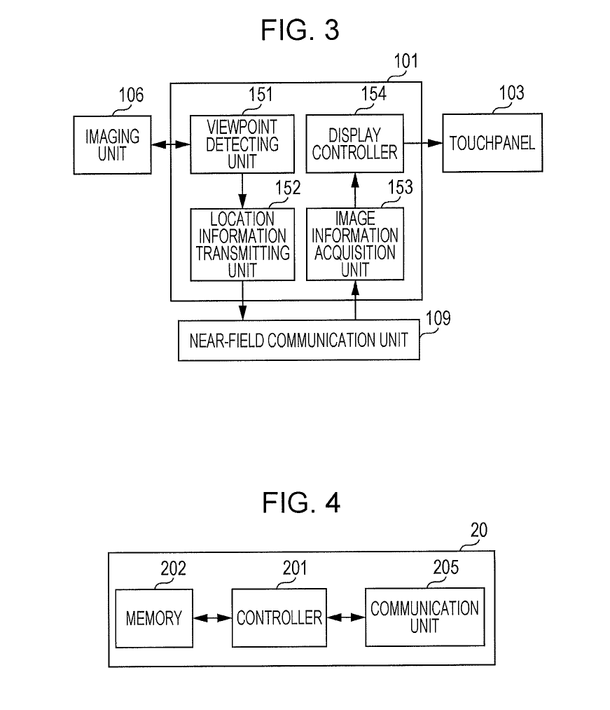

FIG. 3 is a functional block diagram illustrating functions characteristic of the exemplary embodiment from among the functions implemented by the terminal apparatus 10 when the terminal apparatus 10 executes the client application.

A viewpoint detecting unit 151 detects the location of the viewpoint of the user in the display region of the touchpanel 103. The viewpoint detecting unit 151 acquires the image of the face of the user. The viewpoint detecting unit 151 is an example of a generating unit that detects the location of the viewpoint of the user in the display region (coordinates) from the acquired image of the face, and generates location information representing the detected location.

A location information transmitting unit 152 is an example of a location information transmitting unit that transmits to the virtual machine 30 the location information representing the location of the viewpoint detected by the viewpoint detecting unit 151.

An image information acquisition unit 153 is an example of an image information acquisition unit that acquires information representing a screen provided by the virtual machine 30.

A display controller 154 is an example of a display controller that controls the touchpanel 103 using the information acquired by the image information acquisition unit 153 such that the touchpanel 103 displays the screen provided by the virtual machine 30.

FIG. 4 is a block diagram illustrating a hardware configuration of the server apparatus 20. A communication unit 205 works as a communication interface for data communication, and is connected to the communication network 2. A memory 202 includes a device (a hard disk device, for example) configured to continuously store information used by the program or by the virtual machine 30. The programs stored on the memory 202 include an operating system, a word processing program to create and edit documents, a spreadsheet program, a program to reproduce a moving image, and a program to implement the virtual machine 30. The information stored on the memory 202 includes a combination of a user name and a password of a user who is granted to use the server apparatus 20 by an administrator of the server apparatus 20. The memory 202 also stores data used by the user who uses the server apparatus 20. The data used by the user includes a document file used by the word processing program, a spreadsheet file used by the spreadsheet program, and a moving image file used by the program that reproduces the moving image.

A controller 201 includes a CPU and a RAM, executes the operating system, and thus controls the memory 202 and the communication unit 205. When the program implementing the virtual machine 30 is executed, the virtual machine 30 starts up for each user who is authenticated by the server apparatus 20, and is provided to the terminal apparatus used by the connected user.

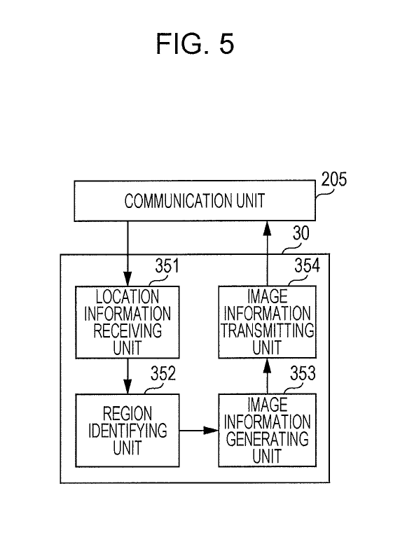

FIG. 5 is a functional block diagram illustrating functions characteristic of the exemplary embodiment from among the functions implemented by the virtual machine 30.

A location information receiving unit 351 is an example of a location information receiving unit that receives location information transmitted from the terminal apparatus 10.

A region identifying unit 352 is an example of a region identifying unit that identifies a first region including a location of a user's viewpoint and a second region other than the first region of a screen provided to the terminal apparatus 10, using the location information acquired by the location information receiving unit 351.

An image information generating unit 353 is an example of an image information generating unit that generates, on a screen to be provided to the terminal apparatus 10, first image information representing an image of an area corresponding to the first region configured by the region identifying unit 352, and second image information representing an image of an area corresponding to the second region configured by the region identifying unit 352.

An image information transmitting unit 354 is an example of an image transmitting unit that transmits the first image information and the second image information, generated by the image information generating unit 353, to the terminal apparatus 10.

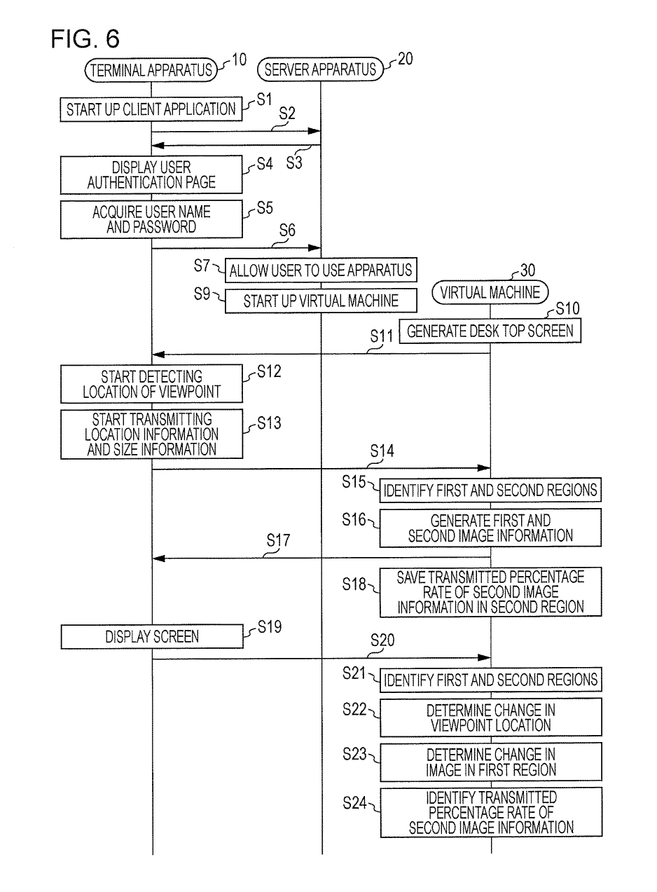

A process example of the embodiment is described below with reference to the drawings. In order to operate the virtual machine 30 from the terminal apparatus 10, a user performs an operation to start up the client application using the touchpanel 103. The controller 101 starts up the client application in response to the operation performed on the touchpanel 103 (step S1 of FIG. 6). Upon starting up the client application, the controller 101 controls the near-field communication unit 109 to access a page for user authentication to use the server apparatus 20 (step S2). In response to the access from the terminal apparatus 10, the server apparatus 20 transmits the page for user authentication to the terminal apparatus 10 (step S3).

When the near-field communication unit 109 receives the page for user authentication, the controller 101 controls the touchpanel 103 to display the received page (step S4). When the user enters the user's own name and password on the user authentication page on the touchpanel 103, the controller 101 acquires the input user name and password (step S5). When the user performs an operation to transmit the input user name and password, the controller 101 controls the near-field communication unit 109 to transmit the combination of the input user name and password to the server apparatus 20 (step S6).

If the combination of the transmitted user name and password is stored on the memory 202, the controller 201 allows the user to use the server apparatus 20 (step S7). Upon allowing the user to use the server apparatus 20, the controller 201 starts up the virtual machine 30 corresponding to the user (step S9). The virtual machine 30 thus started up generates a desk-top screen of the virtual machine 30 (step S10). The virtual machine 30 transmits to the terminal apparatus 10 a message notifying the terminal apparatus 10 that the user has been authenticated (step S11).

When the near-field communication unit 109 receives the message, the controller 101 (the viewpoint detecting unit 151) starts imaging using the imaging unit 106, and starts detecting the location of the user's viewpoint in the display region of the touchpanel 103 (step S12). More specifically, the imaging unit 106 photographs the user′face and thus generates the image of the user's face (hereinafter referred to as a face image). The controller 101 acquires the face image. Upon acquiring the face image, the controller 101 detects the location of the user's viewpoint in the display region of the touchpanel 103 using any appropriate technique available in the related art.

Upon starting detecting the location of the user's viewpoint, the controller 101 (the location information transmitting unit 152) starts transmitting the location information indicating the detected location and size information indicating the size of the display region of the touchpanel 103 (step S13). The controller 101 then transmits the location information and size information to the virtual machine 30 periodically with the period that is predetermined by controlling the near-field communication unit 109 (step S14). The communication unit 205 receives the location information and size information transmitted from the terminal apparatus 10, and the virtual machine 30 (the location information receiving unit 351) acquires the location information and size information received by the communication unit 205.

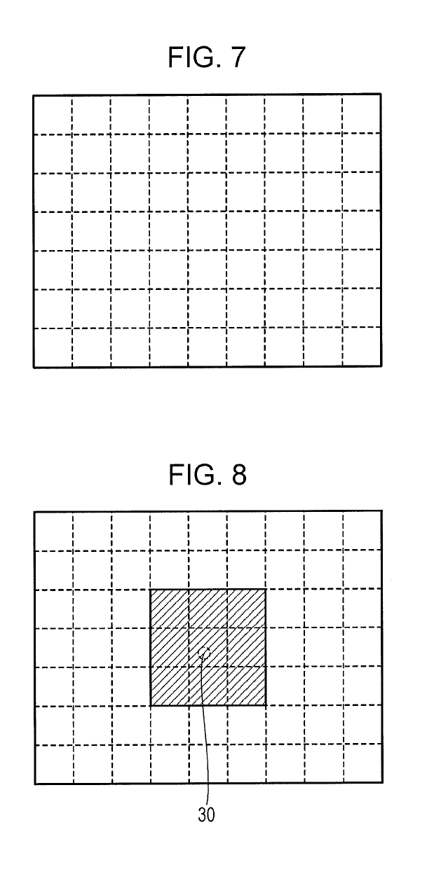

The virtual machine 30 (the region identifying unit 352) identifies the first region and the second region in the display region in accordance with the acquired location information and size information (step S15). The first region is an area that includes the location of the user's viewpoint, and the second region is an area other than the first region. More specifically, the virtual machine 30 segments the display region represented by the size information into a predetermined number of area segments of plural rows and plural columns as illustrated in FIG. 7. The virtual machine 30 configures to be the first area an area segment including the location represented by the location information and area segments surrounding the area segment including the location represented by the location information and the other area segments to be the second region. As illustrated in FIG. 8, area segments at third row and fourth column, third row and fifth column, third row and sixth column, fourth row and forth column, fourth row and fifth column, fourth row and sixth column, fifth row and fourth column, fifth row and fifth column, and fifth row and sixth column are configured to be the first region, and the region excluding the first region is configured to be the second region.

The virtual machine 30 (the image information generating unit 353) identifies the first and second regions, and then generates the first and second image information (step S16). The first image information represents an image in an area corresponding to the first region on a desk-top screen. The first image information has a predetermined image quality (first image quality).

The second image information represents an area corresponding to the second region on the desk-top screen, and is information that is created in accordance with progressive spectral selection technique in Joint Photographic Experts Group (JPEG). By performing discrete cosine transform on the image on the area of the second region, the virtual machine 30 acquires 64 discrete cosine transform (DCT) coefficients. The 64 DCT coefficients represent a direct-current component, a lower frequency component, and a higher frequency component. The virtual machine 30 divides the 64 DCT coefficients into plural blocks, and encodes each divided block to generate the second image information. In accordance with the exemplary embodiment, the DCT coefficients are divided into a first block representing the direct current component, a second block representing the lower frequency component, and a third block representing the higher frequency component. The number of blocks is not limited to three. The DCT coefficients may be divided into two blocks or four or more blocks. The image represented by the information of the first block has an image quality (second image quality) lower than an image quality of the first image information (first image quality). The information of the second block and the third block is an example of supplemental information that changes the image at the second image quality to the image at the first image quality.

The virtual machine 30 (the image information transmitting unit 354) generates the first and second image information, and then controls the communication unit 205 to transmit the information of the first block of the first and second image information to the terminal apparatus 10 (step S17). The virtual machine 30 saves transmitted percentage rate of the second image information forming each area segment of the second region (step S18). The virtual machine 30 saves the percentage rate by which the first block occupies the second image information.

When the near-field communication unit 109 receives the information of the first block of the first and second image information transmitted from the virtual machine 30, the controller 101 (the image information acquisition unit 153) acquires the information received by the near-field communication unit 109. The controller 101 (the display controller 154) controls the touchpanel 103 such that the touchpanel 103 displays the received information on the screen thereof (step S19). In the screen displayed herein, the area of the second region that is displayed in accordance with the information of the first block is blurred because the information of the first block represents the direct-current component on the desk-top screen. The area of the first region that is displayed in accordance with the first image information has a higher image quality because the first image information contains the direct-current component, the lower frequency component, and the higher frequency component on the desk-top screen.

When the terminal apparatus 10 transmits the size information and the location information of the user's viewpoint to the virtual machine 30 (step S20), the virtual machine 30 acquires the size information and the location information of the user's viewpoint. Upon newly receiving the location information, the virtual machine 30 identifies the first and second regions (step S21), and determines whether the location of the user's viewpoint has changed (step S22). The location represented by the previously acquired location information is in the area segment at the fourth row and fifth column. If the location represented by the acquired location information is still in the area segment at the fourth row and fifth column, the virtual machine 30 determines that there has been no change in the location of the user's viewpoint. If the location represented by the acquired location information is in a area segment other than the area segment at the fourth row and fifth column, the virtual machine 30 determines that there has been a change in the location of the user's viewpoint.

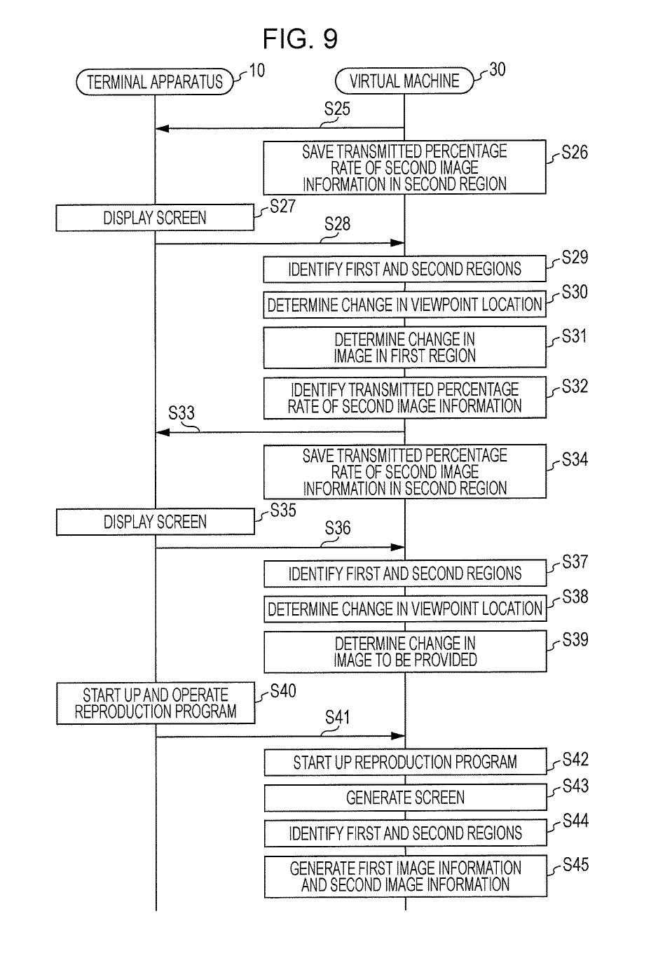

If the location of the user's viewpoint has not changed, the virtual machine 30 determines whether there has been a change in the image in the first region (step S23). If there has been no change in the image in the first region (a hatched portion in FIG. 8) on the screen to be provided to the terminal apparatus 10 since the immediately previous transmission of the first image information, the virtual machine 30 determines what percent of the second image information has been transmitted (step S24). The virtual machine 30 determines the transmitted percentage rate of the information of the first block in response to the second image information based on the percentage rate saved in step S18. If the identified percentage rate equals the percentage rate of the first block, the virtual machine 30 (the image information transmitting unit 354) controls the communication unit 205 to transmit the information of the second block of the second image information in the second region to the terminal apparatus 10 (step S25 of FIG. 9). The virtual machine 30 saves the percentage rate of the transmitted first and second blocks with respect to the second image information (step S26).

When the near-field communication unit 109 receives the information of the second block from the virtual machine 30, the controller 101 controls the touchpanel 103 such that the touchpanel 103 displays a screen where the information of the received first block and the information of the newly received second block appear (step S27). Since the information of the second block represents the lower frequency component of the second region, the area of the second region represented by the information of the first block and the information of the second block provides an image clearer than when the direct-current component alone is used.

When the terminal apparatus 10 transmits the size information and the location information of the location of the user's viewpoint to the virtual machine 30 (step S28), the virtual machine 30 acquires the size information and the location information of the location of the user's viewpoint. Upon newly receiving the location information, the virtual machine 30 identifies the first and second regions (step S29), and determines whether the location of the user's viewpoint has changed (step S30). The location represented by the previously acquired location information is in the area segment at the fourth row and fifth column. If the location represented by the acquired location information is still in the area segment at the fourth row and fifth column, the virtual machine 30 determines that there has been no change in the location of the user's viewpoint.

If the location of the user's viewpoint has not changed, the virtual machine 30 determines whether there has been a change in the image in the first region (step S31). If there has been no change in the image in the first region (the hatched portion in FIG. 8) on the desk-top screen since the immediately previous transmission of the first image information, the virtual machine 30 determines what percent of the second image information has been transmitted (step S32). The virtual machine 30 determines the transmitted percentage rate of the second image information based on the percentage rate saved in step S26. If the determined percentage rate equals the percentage rate of the first block and the second block, the virtual machine 30 (the image information transmitting unit 354) controls the communication unit 205 to transmit the information of the third block of the second image information in the second region to the terminal apparatus 10 (step S33). The virtual machine 30 saves the percentage rate of the transmitted first, second, and third blocks with respect to the second image information (step S34).

When the near-field communication unit 109 receives the information of the third block from the virtual machine 30, the controller 101 controls the touchpanel 103 such that the touchpanel 103 displays the information of the received first block, the information of the received second block, and the information of the newly received third block (step S35). The information of the third block includes the higher frequency component of the second region. The area of the second region that is displayed in accordance with the information of the first through third blocks is as clear in image quality as the first region, in other words, is clearer than when the region is displayed with the direct-current component and the lower frequency component.

When the user moves his or her viewpoint, the controller 101 controls the near-field communication unit 109 to transmit the size information and the location information of the location of the user's viewpoint subsequent to the viewpoint movement to the virtual machine 30 (step S36). The virtual machine 30 acquires the size information and the location information received by the communication unit 205. Upon newly receiving the location information, the virtual machine 30 identifies the first and second regions (step S37), and determines whether the location of the user's viewpoint has changed (step S38). If the location represented by the acquired location information is not in the area segment at the fourth row and fifth column, the virtual machine 30 determines that there has been a change in the location of the user's viewpoint.

If the location of the area segment including the location of the user's viewpoint has changed, the virtual machine 30 determines that there has been a change on the screen the virtual machine 30 provides to the terminal apparatus 10 (step S39). If there has been no change, the virtual machine 30 does not transmit the information representing the screen.

The user may now perform an operation to start up a program to reproduce a moving image (hereinafter referred to as a reproduction program) on a displayed desk-top screen (step S40). The controller 101 controls the near-field communication unit 109 to transmit information representing the operation performed by the user to the virtual machine 30 (step S41). The virtual machine 30 starts up the reproduction program in response to the information from the terminal apparatus 10 (step S42), and generates a screen having a window screen for the reproduction program on the desk-top screen (step S43). The screen to be provided to the terminal apparatus 10 has been changed because the screen newly includes the window screen for the reproduction program.

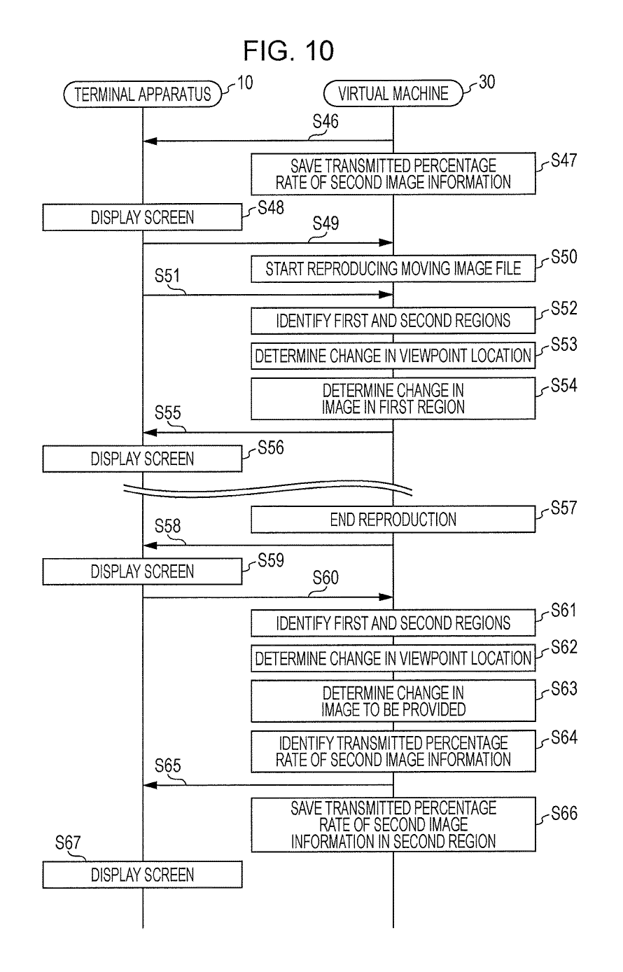

If the screen to be provided to the terminal apparatus 10 has been changed, the virtual machine 30 identifies the first and second regions in accordance with the location represented by the acquired location information (step S44). Upon identifying the first and second regions, the virtual machine 30 generates the first image information and the second image information (step S45). Upon generating the first image information and the second image information, the virtual machine 30 controls the communication unit 205 to transmit the information of the first block of the first image information and the second image information to the terminal apparatus 10 (step S46 of FIG. 10). The virtual machine 30 saves the transmitted percentage rate of the second image information with respect to the area segments forming the second region (step S47). The virtual machine 30 herein saves the percentage rate of the first block with respect to the second image information.

When the near-field communication unit 109 receives the information of the first block of the first image information and the second image information from the virtual machine 30, the controller 101 controls the touchpanel 103 such that the touchpanel 103 displays a screen represented by the received information (step S48). If the first region includes the window screen for the reproduction program, the window screen for the reproduction program has a high image quality screen because it contains the direct-current component, the lower frequency component, and the higher frequency component. On the other hand, a blurred image is displayed on the second region.

If the user performs an operation to reproduce a moving image file in the displayed window of the reproduction program, the controller 101 controls the near-field communication unit 109 to transmit the information representing the operation performed by the user to the virtual machine 30 (step S49). The virtual machine 30 starts reproducing the moving image file in response to the information from the terminal apparatus 10 (step S50). The virtual machine 30 reproduces the moving image file, and updates the image in the window of the reproduction program on the screen to be provided to the terminal apparatus 10.

When the terminal apparatus 10 transmits the size information and the location information of the location of the user's viewpoint to the virtual machine 30 (step S51), the virtual machine 30 acquires the size information and the location information of the location of the user's viewpoint. Upon newly acquiring the location information, the virtual machine 30 identifies the first and second regions (step S52), and determines whether the location of the user's viewpoint has changed (step S53).

If the location of the user's viewpoint has not changed, the virtual machine 30 determines whether there has been a change in the image in the first region (step S54). Since the reproduction program is currently reproducing the moving image file, and the window of the reproduction program is being updated, the virtual machine 30 determines that there has been a change in the image in the first region. If the location of the user's viewpoint remains unchanged but there has been a change in the image in the first region, the virtual machine 30 controls the communication unit 205 to transmit the first image information to the terminal apparatus 10 (step S55).

When the near-field communication unit 109 receives the first image information, the controller 101 displays the image in the first region (step S56). If the user does not move his or her viewpoint until the end of the reproduction of the moving image file, the virtual machine 30 transmits the first image information until the end of the reproduction of the moving image file, but does not transmit the second image information. The terminal apparatus 10 updates the image in the window of the reproduction program until the end of the reproduction of the moving image file. The image in the second region remains blurred because the terminal apparatus 10 receives only the information of the first block. When the virtual machine 30 completes the reproduction of the moving image file (step S57), the image in the window of the reproduction program becomes a predetermined still image and this image is transmitted to the terminal apparatus 10 (step S58) to be displayed there (step S59).

When the terminal apparatus 10 transmits the size information and the location information of the location of the user's viewpoint to the virtual machine 30 (step S60), the virtual machine 30 acquires the size information and the location information of the location of the user's viewpoint. Upon newly receiving the location information, the virtual machine 30 identifies the first and second regions (step S61), and determines whether the location of the user's viewpoint has changed (step S62). If the location of the user's viewpoint has not changed, the virtual machine 30 determines whether there has been a change in the image in the first region (step S63). If the window of the reproduction program displays a still image, and there has been no change on the desk-top screen, the virtual machine 30 determines that there has been no change in the image in the first region.

If there has been no change in the first region, the virtual machine 30 identifies what percent of the second image information has been transmitted (step S64). The virtual machine 30 identifies the transmitted percentage rate of the information of the first block in the second image information based on the percentage rate saved in step S47. If the identified percentage rate is the percentage rate of the first block, the virtual machine 30 controls the communication unit 205 to transmit the information of the second block of the second image information in the second region to the terminal apparatus 10 (step S65). Also, the virtual machine 30 saves the percentage rate of the transmitted first and second blocks with respect to the second image information (step S66).

When the near-field communication unit 109 receives the information of the second block from the virtual machine 30, the controller 101 controls the touchpanel 103 such that the touchpanel 103 displays a screen represented by the information of the first block received and the information of the second block newly received (step S67). Since the information of the second block contains the lower frequency component of the second region, the second region represented by the information of the first block and the information of the second block is displayed in a clearer state than when the second region is displayed with the direct-current component alone.

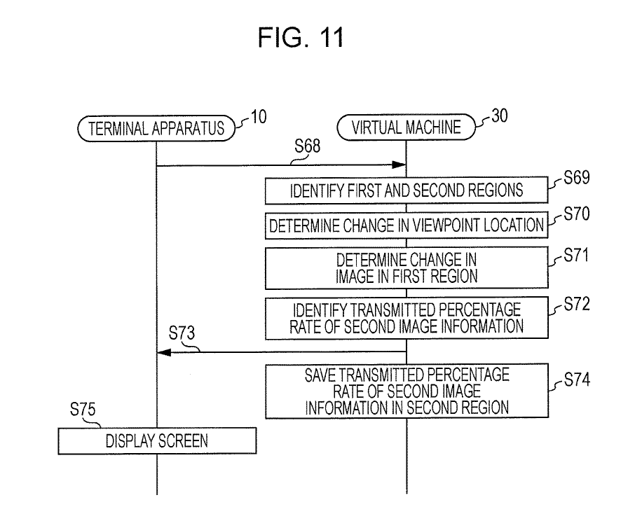

When the terminal apparatus 10 transmits the size information and the location information of the location of the user's viewpoint to the virtual machine 30 (step S68 of FIG. 11), the virtual machine 30 acquires the size information and the location information of the location of the user's viewpoint. Upon newly receiving the location information, the virtual machine 30 identifies the first and second regions (step S69), and determines whether the location of the user's viewpoint has changed (step S70).

If the location of the user's viewpoint has not changed, the virtual machine 30 determines whether there has been a change in the first region (step S71). If there has been no change the first region since the immediately previous transmission of the first image information, the virtual machine 30 identifies what percent of the second image information has been transmitted (step S72). The virtual machine 30 identifies the transmitted percentage rate of the second image information based on the percentage rate saved in step S66. If the identified percentage rate is the percentage rate of the first and second blocks, the virtual machine 30 controls the communication unit 205 to transmit the information of the third block of the second image information in the second region to the terminal apparatus 10 (step S73). Also, the virtual machine 30 saves the transmitted percentage rate of the first through third blocks with respect to the second image information (step S74).

When the near-field communication unit 109 receives the information of the third block from the virtual machine 30, the controller 101 controls the touchpanel 103 such that the touchpanel 103 displays a screen represented by the information of the received first block, the information of the received second block, and the information of the newly received third block (step S75). Since the information of the third block contains the higher frequency component of the second region, the second region represented by the information of the first through third blocks is displayed as an image as clear as in the first region, in other words, displayed in a clearer state than when the second region is displayed with only the direct-current component and the lower frequency component.

The exemplary embodiment of the present invention has been discussed. The present invention is not limited to the exemplary embodiment, and may be implemented in a variety of the exemplary embodiments. The exemplary embodiment may be modified as described below. The exemplary embodiment and the modifications described below may be combined.

According to the exemplary embodiment, the screen to be provided to the terminal apparatus 10 is divided into area segments of plural rows and plural columns in accordance with the size of the display region of the touchpanel 103. The method of dividing the screen to be provided to the terminal apparatus 10 into the plural area segments is not limited to the method of the exemplary embodiment. For example, the distance from the touchpanel 103 to the face of the user may be detected, an effective field of view may be identified based on the distance from the touchpanel 103 to the face of the user (distance between the touchpanel 103 and the eyeballs of the user), the location of the viewpoint of the user, and a predetermined viewing angle. An effective field of view or a human standard overall field of view may be configured to be the first region. The human standard overall field of view is defined as an overall field of view covered when one turns the head around or tilts the head up or down without any difficulty and without changing one's body position. The remaining region may be configured to be the second region. With a window included in the screen treated as a unit, a region having the location of the user's viewpoint in the window may be configured to be the first region, and the remaining region may be configured to be the second region.

According to the exemplary embodiment, the information of the second block or the third block of the second image information is transmitted with reference to the plural area segments forming the second region, starting with information closer to the first region.

For example, the information of the second block may now be transmitted with respect to the first region hatched as illustrated in FIG. 8. From among the plural area segments forming the second region, the information of the second block is transmitted, starting with area segments in contact with the first region (area segments at second row and each of the third to seventh columns, third row and third column, third row and seventh column, fourth row and third column, fourth row and seventh column, fifth row and third column, fifth row and seventh column, and sixth row and each of third through seventh columns). After transmitting the information of the second block at the plural area segments in contact with the first region, the information of the second block in the remaining area segments is then transmitted. The information of the third block may be transmitted in a similar fashion.

The information of the second block of the plural area segments forming the second region may be transmitted in the order of the area segments from an area segment having a higher amount of information to an area segment having a lower amount of information. For example, a window displaying a still image and a window displaying a word processor may be present in the second region, and the amount of information of the window displaying the still image may be higher than the amount of information of the window displaying the word processor. In such a case, the information of the second block is transmitted, starting with the window displaying the still image. After transmitting the information of the second block of the window displaying the still image, the information of the second block of the window displaying the word processor may be transmitted. The same may be true of the third block.

If the virtual machine 30 provides a screen having plural windows opened, a window having the user's viewpoint may be configured to be the first region, and the information of the second block may be transmitted, starting with a window closer to the first region. The same is true of the information of the third block.

In a modification of the exemplary embodiment, the user's viewpoint may be in the window of the reproduction program, and the user's viewpoint may move while the reproduction program is reproducing the moving image file. In such a case, the first and second regions may be reconfigured in response to the location of the user's viewpoint subsequent to the movement. The first block of the first image information responsive to the reconfigured first region and the second image information responsive to the reconfigured second region may be transmitted to the terminal apparatus 10. In this modification, if the second region contains the window of the reproduction program as a result of movement of the user's viewpoint, the terminal apparatus 10 may display the screen based on the information of the first block. Since the window of the reproduction program is displayed with the direct-current component only of the screen, a blurred image results. If there has been no further change in the image in the first region with the user's viewpoint remaining fixed, the information of the second block and the information of third block are transmitted. The window of the reproduction program becomes successively higher in image quality.

According to the exemplary embodiment, the second region becomes successively higher in image quality because the information of the second region is transmitted in the order from the information of the first block (direct-current component), the information of the second block (lower frequency component), and the information of the third block (higher frequency component) in this order. The method of successively increasing the image quality of the second region is not limited to the method of the exemplary embodiment. For example, information representing chroma is divided into plural levels and then transmitted to the terminal apparatus 10. The second region is successively increased in image quality. Information indicating value may be divided into plural levels, and then transmitted to the terminal apparatus 10. The second region is successively increased in image quality.

In the exemplary embodiment, the first image information may be information in a format similar to the format of the second image information. The information of the first through third blocks may be collectively transmitted to the terminal apparatus 10.

A program of each apparatus of the exemplary embodiment and modifications may be provided in a stored state on a non-transitory computer readable medium, and may be installed on a computer. Such media include magnetic recording media (including a magnetic tape, a magnetic disk (such as a hard disk drive (HDD)), or a flexible disk (FD)), an optical recording medium (such as an optical disk), a magneto-optical recording medium, and a semiconductor memory. The program may be downloaded and installed on the computer via a communication network.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A server apparatus comprising:
a location information receiving unit that receives location information representing a location of a user's viewpoint in a display region of a terminal apparatus;
a region identifying unit that identifies, on a screen provided to the terminal apparatus, a first region determined by the location information and a second region other than the first region; and
an image transmitting unit that transmits to the terminal apparatus an image at a first image quality corresponding to the first region for an area of the first region of the provided screen and transmits, to the terminal apparatus, supplemental information that supplements an image at a second image quality lower than the first image quality up to a level of the first image quality after transmitting the image at the second image quality for an area of the second region of the provided screen.

2. The server apparatus according to claim 1, wherein the image transmitting unit transmits the supplemental information after transmitting the image at the first image quality.

3. The server apparatus according to claim 2, wherein the image transmitting unit transmits the supplemental information if no change has occurred in the image in the first region after transmitting the image at the second image quality.

4. The server apparatus according to claim 1, wherein the second region comprises a plurality of area segments, and
wherein the image transmitting unit transmits the supplemental information of the image in the area of the second region in an order of the area segments from an area segment closer to the first region to an area segment farther from the first region.

5. The server apparatus according to claim 2, wherein the second region comprises a plurality of area segments, and
wherein the image transmitting unit transmits the supplemental information of the image in the area of the second region in an order of the area segments from an area segment closer to the first region to an area segment farther from the first region.

6. The server apparatus according to claim 3, wherein the second region comprises a plurality of area segments, and
wherein the image transmitting unit transmits the supplemental information of the image in the area of the second region in an order of the area segments from an area segment closer to the first region to an area segment farther from the first region.

7. The server apparatus according to claim 1, wherein the second region comprises a plurality of area segments, and
wherein the image transmitting unit transmits the supplemental information of the image in the area of the second region in an order of the area segments from an area segment having a higher amount of information to an area segment having a lower amount of information.

8. The server apparatus according to claim 2, wherein the second region comprises a plurality of area segments, and
wherein the image transmitting unit transmits the supplemental information of the image in the area of the second region in an order of the area segments from an area segment having a higher amount of information to an area segment having a lower amount of information.

9. The server apparatus according to claim 3, wherein the second region comprises a plurality of area segments, and
wherein the image transmitting unit transmits the supplemental information of the image in the area of the second region in an order of the area segments from an area segment having a higher amount of information to an area segment having a lower amount of information.

10. The server apparatus according to claim 1, wherein the region identifying unit acquires a distance between the display region of the terminal apparatus and a user, and configures to be the first region a region that is determined by the acquired distance, a predetermined viewing angle, and the location information.

11. The server apparatus according to claim 2, wherein the region identifying unit acquires a distance between the display region of the terminal apparatus and a user, and configures to be the first region a region that is determined by the acquired distance, a predetermined viewing angle, and the location information.

12. The server apparatus according to claim 3, wherein the region identifying unit acquires a distance between the display region of the terminal apparatus and a user, and configures to be the first region a region that is determined by the acquired distance, a predetermined viewing angle, and the location information.

13. The server apparatus according to claim 4, wherein the region identifying unit acquires a distance between the display region of the terminal apparatus and a user, and configures to be the first region a region that is determined by the acquired distance, a predetermined viewing angle, and the location information.

14. The server apparatus according to claim 5, wherein the region identifying unit acquires a distance between the display region of the terminal apparatus and a user, and configures to be the first region a region that is determined by the acquired distance, a predetermined viewing angle, and the location information.

15. The server apparatus according to claim 6, wherein the region identifying unit acquires a distance between the display region of the terminal apparatus and a user, and configures to be the first region a region that is determined by the acquired distance, a predetermined viewing angle, and the location information.

16. The server apparatus according to claim 7, wherein the region identifying unit acquires a distance between the display region of the terminal apparatus and a user, and configures to be the first region a region that is determined by the acquired distance, a predetermined viewing angle, and the location information.

17. The server apparatus according to claim 8, wherein the region identifying unit acquires a distance between the display region of the terminal apparatus and a user, and configures to be the first region a region that is determined by the acquired distance, a predetermined viewing angle, and the location information.

18. An information processing system comprising a server apparatus and a terminal apparatus,
wherein the server apparatus includes:
a location information receiving unit that receives location information representing a location of a user's viewpoint in a display region of the terminal apparatus;
a region identifying unit that identifies, on a screen provided to the terminal apparatus, a first region determined by the location information and a second region other than the first region; and
an image transmitting unit that transmits to the terminal apparatus an image at a first image quality corresponding to the first region for an area of the first region of the provided screen and transmits, to the terminal apparatus, supplemental information that supplements an image at a second image quality lower than the first image quality up to a level of the first image quality after transmitting the image at the second image quality for an area of the second region of the provided screen, and
wherein the terminal apparatus includes:
a generating unit that detects the location of the user's viewpoint in the display region of the terminal apparatus and generates the location information representing the detected location;
a location information transmitting unit that transmits to the server apparatus the location information generated by the generating unit;
an image information acquisition unit that acquires the image and the supplemental information transmitted by the image transmitting unit; and
a display controller that controls a display to display an image represented by the image and the supplemental information acquired by the image information acquisition unit.

19. A terminal apparatus, comprising:
a generating unit that detects a location of a user's viewpoint in a display region of the terminal apparatus and generates location information representing the detected location;
a location information transmitting unit that transmits the location information generated by the generating unit to a server apparatus, the server apparatus including a location information receiving unit that receives the location information representing the location of the user's viewpoint in the display region of the terminal apparatus, a region identifying unit that identifies, on a screen provided to the terminal apparatus, a first region determined by the location information and a second region other than the first region, and an image transmitting unit that transmits to the terminal apparatus an image at a first image quality corresponding to the first region for an area of the first region of the provided screen and transmits, to the terminal apparatus, supplemental information that supplements an image at a second image quality lower than the first image quality up to a level of the first image quality after transmitting the image at the second image quality for an area of the second region of the provided screen;
an image information acquisition unit that acquires the image and the supplemental information transmitted by the image transmitting unit; and
a display controller that controls a display to display an image represented by the image and the supplemental information acquired by the image information acquisition unit.

20. A non-transitory computer readable medium storing a program causing a computer to execute a process for processing information, the process comprising:
receiving a location of a user's viewpoint in a display region of a terminal apparatus;
identifying, on a screen provided to the terminal apparatus, a first region determined by the location information and a second region other than the first region; and
transmitting to the terminal apparatus an image at a first image quality corresponding to the first region for an area of the first region of the provided screen and transmits, to the terminal apparatus, supplemental information that supplements an image at a second image quality lower than the first image quality up to a level of the first image quality after transmitting the image at the second image quality for an area of the second region of the provided screen.
